(19) United States
(12) Patent Application Publication
(10) Pub. No.: US 2025/0158503 A1
(43) Pub. Date: May 15, 2025

(54) System for Conversion of Capacitive Reactive Current into Useful Energy

(71) Applicant: Rafael Pazos Jimenez, Hermosillo (MX)

(72) Inventor: Rafael Pazos Jimenez, Hermosillo (MX)

(21) Appl. No.: 18/949,202

(22) Filed: Nov. 15, 2024

Related U.S. Application Data
(60) Provisional application No. 63/599,466, filed on Nov. 15, 2023.

(51) Int. Cl. H02M 1/00; H01F 27/28

(52) U.S. Cl. CPC H02M 1/0003; H01F 27/2823

(57) ABSTRACT

A system for converting the alternating electric field produced by the capacitive reactive current circulating in wires that connect an electric capacitor that produces the alternating electric field into useful energy. The system comprises a power source, at least one switch electrically connected to the power source, and at least one transformer electrically connected to the switch. A wire is wound about the ferromagnetic core of the transformer a predetermined number of times sufficient to create an electrical field when energized by the capacitor. The system further comprises at least one capacitor electrically connected to the switch, the transformer and to a rectifier.

### CROSS REFERENCE TO RELATED APPLICATIONS

This original non-provisional patent application claims priority to and the benefit of U.S. provisional application Ser. No. 63/599,466, filed Nov. 15, 2023, and entitled “Converter of Capacitive Reactive Amperes into Useful Energy,” which is incorporated by reference herein.

### STATEMENT REGARDING FEDERALLY SPONSORED RESEARCH OR DEVELOPMENT

None.

### BACKGROUND OF THE INVENTION

### 1. Technical Field of the Invention

The present invention relates to conversion of an electric field produced by capacitive reactive current (amperes) into useful energy by connecting one or more capacitors to make efficient use of electrical energy. More specifically, the present invention relates to a system for converting the alternating electric field produced by the capacitive reactive power circulating in the wires that connect the electric capacitor (that produces the alternating electric field) into useful energy.

### 2. State of the Art

Currently there are different ways and methods to produce clean energy and others seeking their efficiency, some in development and some in use, such as wind energy and eolic generators and the use of photovoltaic panels (i.e., solar panels) among others. One of the methods to make the use of electrical energy more efficient—and to reduce the production and generation of the inductive reactive power necessary to create the electric field of motors and any electrical device that demands efficient electrical energy—is the installation of capacitors for the correction of the power factor. The installed capacitors provide the reactive power necessary for the different electrical devices to work more efficiently. That is to say, that one of the methods used for energy saving is the use of capacitors on the low voltage side of transformers to provide reactive power, the ideal point being as close as possible to the devices. With the use of capacitors to provide the reactive power demanded by the different devices and transformers, savings are achieved by avoiding their production in the generation (e.g., generation plants), transmission, transformation, distribution and delivery of the demanded reactive power to the end user. Another method to save energy is the use of variable frequency drives (VFDs) in electric motors, etc.

All transformers experience a 20% to 30% electrical loss when stepping the utility power down from the grid to the end user (e.g., house, government). The utilities pay this loss. In other words, the utility companies need to produce 140% power to get 100% power. The present invention reduces not only this 20% to 30% loss, but also up to about approximately 80% additional reduction of this loss.

### 3. Problem to be Solved with the Present Invention

By circulating capacitive reactive current (amperes) through the electrical wires connecting one or more capacitors, the electrical wires produce an electric field that is wasted and has no use. The present invention takes advantage of the electric field produced by the alternating capacitive reactive current amperes circulating through electrical wires connecting one or more electric capacitors, thereby converting the electric field into useful energy. The present invention can be used in any type of load, like inductive loads, reactive loads and resistive loads. The useful electrical energy produced by this invention is completely isolated from the conventional electrical network (i.e., the grid) so the produced electrical energy is free of any distortion, e.g., without producing harmonics distortions in the electric grid, in the quality of electrical energy. The produced electrical energy can also be rectified—e.g., converted from alternating current (AC) to direct current (DC)—to store such energy in batteries, or transformed for local use (e.g., used for lighting), or returned to the conventional electrical network (i.e., the grid).

### BRIEF DESCRIPTION OF THE SEVERAL VIEWS OF THE DRAWINGS

FIG. 1 shows the conventional connection of a 0.83 Kilovolt-Ampere Reactive (KVAR), 240 volts alternating current single-phase capacitor and capacitive reactive amps circulating from a switch. KVAR is the measure of reactive power.

FIG. 2 depicts the current transformer in an embodiment of the present invention.

FIG. 3 shows a diagram with the main electrical components with respect to FIG. 4 for better understanding of the present invention.

FIG. 4 depicts a single-phase embodiment of the present invention to explain how capacitive reactive current is converted into useful energy with the present invention.

FIG. 5 depicts a diagram of the multi-phase embodiment of the present invention unified into a single output or circuit.

FIG. 6 depicts a schematic illustrating the necessary elements for an alternative embodiment of the present invention.

### BRIEF SUMMARY OF THE INVENTION

The present invention comprises the use of one or more current transformers of any transformation ratio, voltage level and capacity in volt-amperes (VA) electrically connected to one or more capacitors in all KVAR capacities, to an inductive or resistive electric load or any other type of electric load that generates ferromagnetic fields to be converted into watts, whether connected on the secondary side or on the primary side regardless of the capacity, caliber or quantity of the winding copper wire. The energy converted by the system of the present invention may then be used by any electrically demanding device (regardless of the size, capacity and characteristics of any device) with the characteristics of voltage, amperage and frequency. Conversion as used in this application relates to the conversion of power from the magnetic field to electricity.

### DETAILED DESCRIPTION OF THE INVENTION

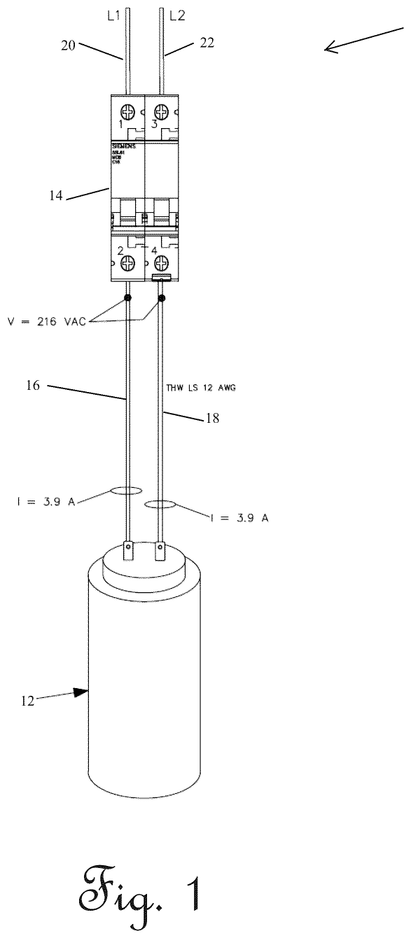

Referring now to FIG. 1, capacitor 12 of conventional system 10 is connected to switch 14 via connectors 16 and 18. Capacitor 12 is a 0.83 KVAR, 240 volts alternating current single-phase capacitor. Power (alternating current) enters switch 14 via input line 20. Capacitive reactive amps, i.e., current, circulate from switch 14 to capacitor 12. The test voltage of the capacitive reactive current is 216 VAC (Volts Alternating Current) between phases and 3.9 amps in each phase. Power then exits switch 14 via output line 22. Capacitor 12 provides reactive power to the power grid (not shown) in a conventional way.

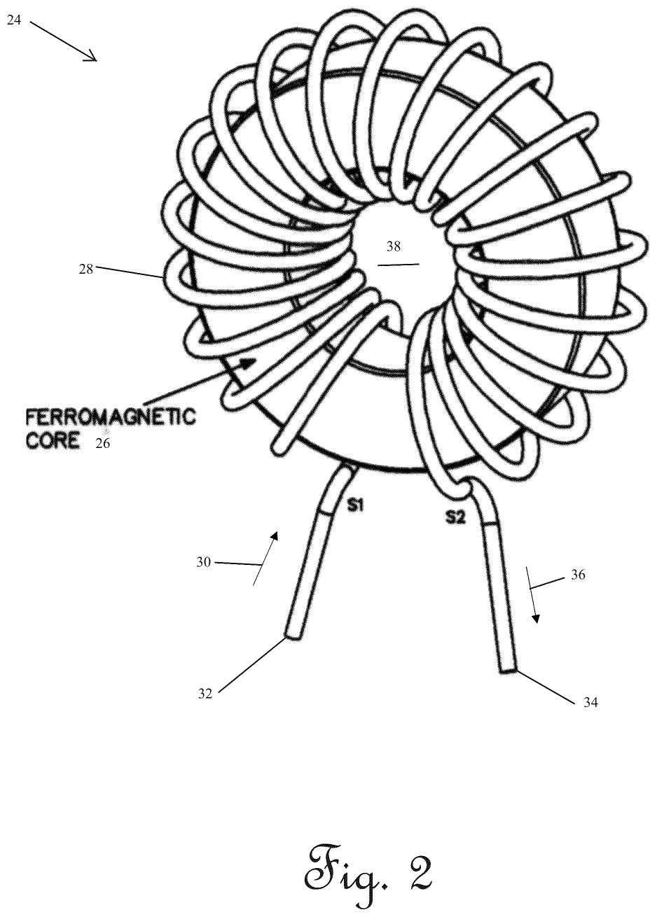

Before discussing the development of the present invention, it is necessary to explain how the current transformer of the present invention is constructed. Referring now to FIG. 2, ferromagnetic core (e.g., magnet) 26 is wound many times with an inductor coil or cable 28, and is referred to as a winding. Current travels through transformer 24 in the direction of arrow 30 beginning at end 32 of cable 28, traverses the length of cable 28, and exits transformer 24 at end 34 in the direction of arrow 36. Cable 28 in the present invention is a copper cable, though other comparably conductive material may be used and still remain within the contemplation of the present invention. Ferromagnetic core 26 is constructed of materials having magnetic properties. When current traverses copper cable 28, copper cable 28 becomes energized. When an energized wire or cable, e.g., energized copper cable 28, crosses through center 38 of current transformer 24, the electric field produced (not shown) is absorbed by ferromagnetic core 26 and transmitted to secondary winding S1 and S2. Conversely, when an energized wire enters through secondary winding S1 and S2, the energized wire also produces an electric field in the ferromagnetic core.

Though FIG. 2 only shows a single ferromagnetic core wrapped with a copper cable, additional cable wrapped ferromagnetic cores may also be used together and still remain within the contemplation of the present invention.

The present invention uses the reactive-capacitive amps that connect the capacitors circulating them through the secondary winding (S1 and S2), inducing the electric field produced by the reactive-capacitive amps to ferromagnetic core 26 of current transformer 24.

The number of turns that the copper cable makes around the ferromagnetic core may vary. For instance, as an example, there can be ten (10) turns of the copper cable around the ferromagnetic core. However, the present invention can also accommodate additional turns of copper cable 28 around ferromagnetic core 24. As another example, there can be twenty (20) turns of copper cable 28 around ferromagnetic core 26, as shown in FIG. 2. The more turns there are, the more energy that is converted. As such, the number of turns is dependent upon the desired power output.

The present invention uses copper wire or cable, winding gauge AWG 6 and AWG 8. However, other sized or gauged cable of comparable conductive material is also contemplated to be used and still remain within the contemplation of the present invention.

The ferromagnetic core used in the present invention is a commercially available nuclear ferromagnetic magnet, REL. 1500:5, PREC. 0.5%, AMPS. 0.72 VKV, 50.0 VA, 50-60 HZ, Mod. TCD12-1500S0, No. OF2102552-17, NOM-1 by Equipos Eléctricos core, S. A. under the CORE brand and having a 2.5-inch outer diameter. However, a core comprised of a material having comparable ferromagnetic properties or characteristics and having either a larger or smaller outer diameter may also be used and still remain within the contemplation of the present invention.

The present invention uses at least two ferromagnetic cores, e.g., magnets, in the system. However, the present invention can accommodate many more ferromagnetic cores. The only caveat is that the ferromagnetic cores added to the system of the present invention must be done in pairs (e.g., 2, 4, 6, etc. . . . ). The first ferromagnetic core captures the magnetic field and transfers to the second ferromagnetic core. The second ferromagnetic core converts the magnetic field to electricity that can then be used.

The capacitor used in the present invention is a UCWT-2.50 V54 HD 10045995, 50-60 HZ commercially available under the WEG brand by WEG Electric Corp. However, other comparable capacitors may also be used and still remain within the contemplation of the present invention.

The present invention may also accommodate several capacitors in a single system. The number of capacitors used depends upon the power requirements of the application. For instance, up to 20 capacitors may be used in a single system, though the present invention may accommodate either more or less and still be within the contemplation of the present invention.

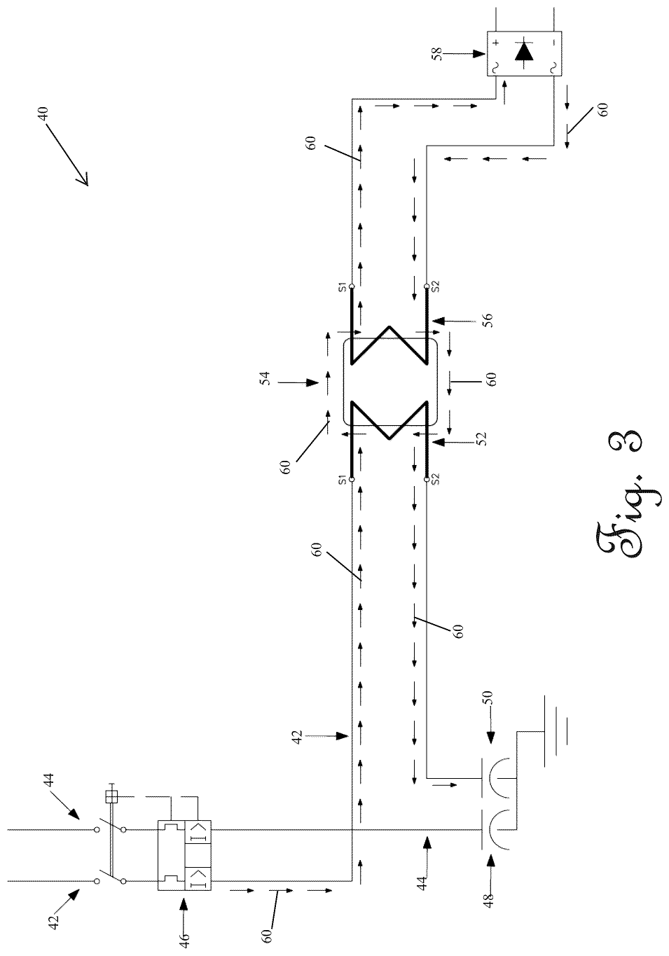

Now referring to FIG. 3, diagram 40 of the main electrical components is shown. These main electrical components comprise wire line 42, wire line 44, switch 46, capacitors 48 and 50, transformer 52, cable winding 54, transformer 56, and rectifier bridge 58. Capacitors 48 and 50 are 0.83 KVAR-240 VAC, 2 Phase. Transformers 52 and 56 have ratios of 1500:5-50 Va, 60 Hz, 600 volts. Cable winding 54 has a winding gauge of 6 AWG. The flow path of the current within the system follows the direction of arrow 60.

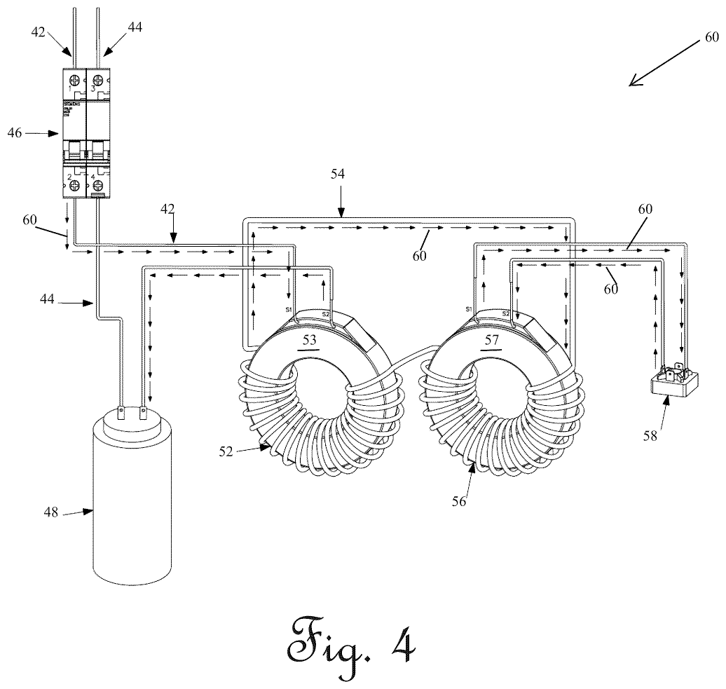

Referring now to FIG. 4, embodiment 60 of the invention is shown. This embodiment includes a single-phase device. A small capacitor 48 (0.83 KVAR, 240 volts alternating current capacitor) flows 3.5 amps through current transformers 52 and 56. The converted resulting useful energy is 20 watts, with 10 wounds or windings over the current transformer 52 and 10 wounds or windings over the current transformer 56. Increasing the number of windings in the current transformers increases the number of converted watts. By increasing the capacity and quantity of capacitors, the desired converted useful energy increases.

FIG. 4 illustrates how capacitive reactive current is converted into useful energy with the system of the present invention. By connecting lines 42 and 44 (similar to L1 and L2 from FIG. 1), capacitor 48 is energized, flowing reactive-capacitive amps or current enters through connection S1 of current transformer 52 and exits through connection S2 of current transformer 52 towards capacitor 48. When the current flows through connection S1 and exits through connection S2 towards capacitor 48, an electric field is produced which is induced in ferromagnetic core 53 of current transformer 52. Wire winding 54 transmits the electric field from ferromagnetic core 53 of current transformer 52 to induce the electric field into ferromagnetic core 57 of current transformer 56. The electric field in ferromagnetic core 57 of current transformer 56 is delivered via connections S1 and S2 of current transformer 56, converted into watts which may be used for different uses, rectified and stored in batteries, transformed for local uses, or returned to the electrical power grid.

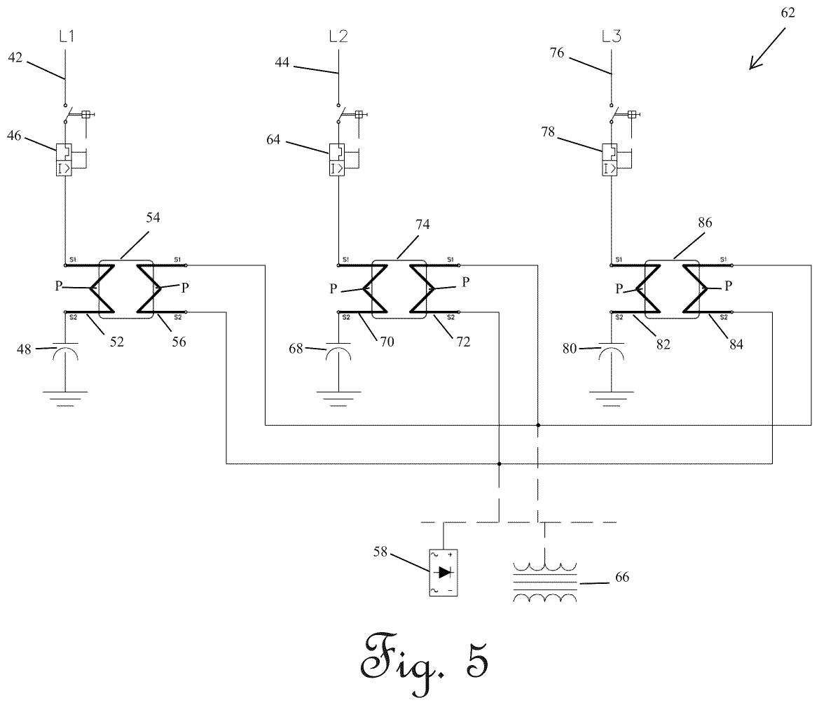

While only one phase is shown in FIG. 4, conversion of an electric field into usable energy from a single-phase and three-phase device may also be performed using the system of the present invention. For example, a feature of the present invention is that the energy converted into different phases may be unified into a single output or circuit, as shown in the diagram in FIG. 5. It is, therefore, contemplated that use of these multi-phase devices falls within the scope of the present invention.

Referring now to FIG. 5, schematic 62 depicts the convergence of different phases into a single output or circuit. The three phases are depicted by lines L1, L2, and L3. The function of line L1 mirrors the description above relating to a single phase, as shown in FIG. 4, except that now there are three different phases. For the second phase, connecting line L2 (or line 44) energizes capacitor 68, flowing reactive-capacitive amps or current enters through connection S1 of current transformer 70 and exits through connection S2 of current transformer 70 towards capacitor 68. When the current flows through connection S1 and exits through connection S2 towards capacitor 68, an electric field is produced which is induced in the ferromagnetic core of current transformer 70. Wire winding 74 transmits the electric field from the ferromagnetic core of current transformer 70 to induce the electric field into the ferromagnetic core of current transformer 72. The electric field in the ferromagnetic core of current transformer 72 is delivered via connections S1 and S2 of current transformer 72, converted into watts which may be used for different uses, rectified and stored in batteries, transformed for local uses, or returned to the electrical power grid.

Similarly, and still referring to FIG. 5, connecting line L3 (or line 76) energizes capacitor 80, flowing reactive-capacitive amps or current enters through connection S1 of current transformer 80 and exits through connection S2 of current transformer 80 towards capacitor 80. When the current flows through connection S1 and exits through connection S2 towards capacitor 80, an electric field is produced which is induced in the ferromagnetic core of current transformer 82. Wire winding 86 transmits the electric field from the ferromagnetic core of current transformer 82 to induce the electric field into the ferromagnetic core of current transformer 84. The electric field in the ferromagnetic core of current transformer 84 is delivered via connections S1 and S2 of current transformer 84, converted into watts which may be used for different uses, rectified and stored in batteries, transformed for local uses, or returned to the electrical power grid.

Each of lines L1, L2 and L3 (lines 42, 44 and 76, respectively) converge together and are unified into a single output or circuit, e.g., bridge rectifier 58 or transformer 66, as shown in FIG. 5.

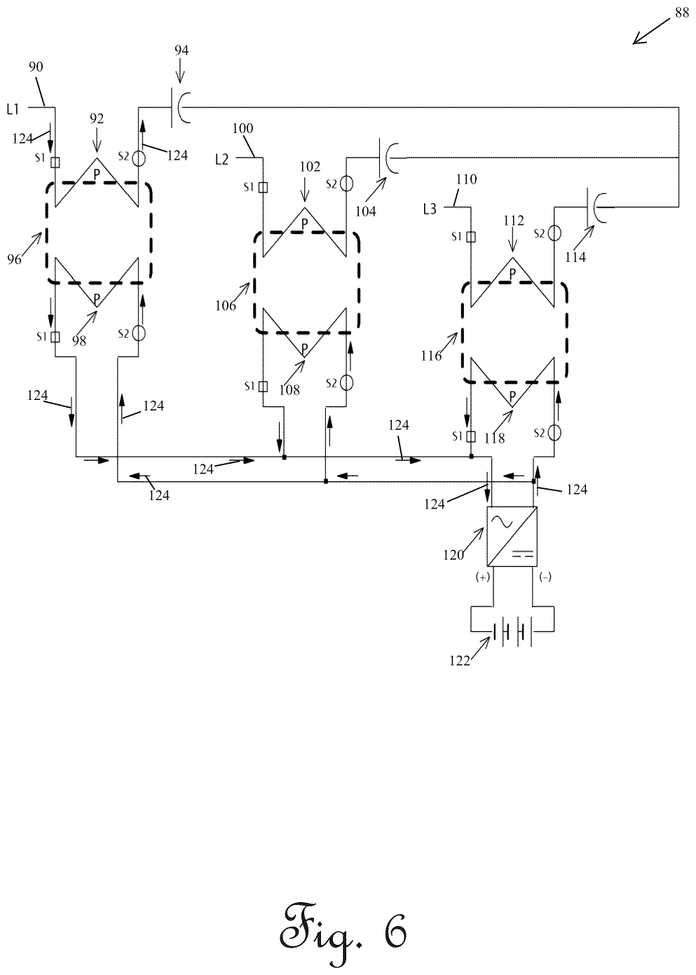

In an alternative embodiment, the system of the present invention may be in a parallel circuit configuration, as shown in FIG. 6. Schematic 88 depicts the various components that comprise this alternative embodiment. Line L1 (or line 90) is connected to input terminal or connection S1 of first current transformer 92 causing a number of amperes or a large amount of current to circulate out of secondary or exit terminal S2 of first current transformer 92 to three-phase capacitor 94 producing an electric field. Copper wire or cable 96 is wound several times about first current transformer 92 on primary side P of first current transformer 92. The ends of copper wire 96 are connected and wound the same number of turns on primary side P of second current transformer 98. The ferromagnetic core of first current transformer 92 transmits the electric field produced to second current transformer 98 using first winding 96, converting the produced electric field into watts of power that can be used, for example, in lighting, alternating current motors, electric heaters, stored in batteries or returned to the conventional electricity grid.

Still referring to FIG. 6, line 100 (L2) is connected to input terminal S1 of third current transformer 102 which causes several amperes or large amounts of current to circulate out through secondary or exit terminal S2 of third current transformer 102 to capacitor 104 producing an electric field. Second winding of copper wire or cable 106 is wound a number of times about third current transformer 102 on primary side P of third current transformer 102. The ends of copper wire 106 are connected and wound the same number of turns on primary side P of fourth current transformer 108. The ferromagnetic core of third current transformer 102 transmits the electric field produced to fourth current transformer 108 using second winding of copper wire 106, converting the produced electric field into watts of power that can be used in lighting, alternating current motors, electric heaters, stored in batteries or returned to the conventional electricity grid.

Still referring to FIG. 6, line 110 (L3) is connected to input terminal S1 of fifth current transformer 112 causing a number of amperes or large amounts of current to circulate out of secondary or exit terminal S2 of fifth current transformer 112 to capacitor 114 producing an electric field. Copper wire 116 (third winding) is wound a number of times about fifth current transformer 112 on primary side P of fifth current transformer 112. The ends of copper wire 116 are connected and wound the same number of turns on primary side P of sixth current transformer 118. The ferromagnetic core of fifth current transformer 112 transmits the electric field produced to sixth current transformer 118 using the third winding of copper wire 116, converting the produced electric field into watts of power that can be used in lighting, alternating current motors, electric heaters, stored in batteries or returned to the conventional electrical network.

As shown in FIG. 6, there are six (6) current transformers (92, 98, 102, 108, 112, 118). While the present invention uses current transformers with ratios of 1500:5, 50 VA, other types of transformers with comparable ratios may also be used and still remain within the contemplation of the present invention.

The present invention uses three (3) wire windings (96, 16, 116), each comprised of copper and having a cable gauge size of 8 AWG. However, wire windings of comparable conductive material and gauge size may also be used and still remain within the contemplation of the present invention.

There are three (3) capacitors (94, 104, 114), each being three-phased, 1 KVAR, 220 Volts. Each capacitor designates a different phase (e.g., phase 1, phase 2, phase 3). However, capacitors of comparable properties may also be used and still remain within the contemplation of the present invention.

A special feature of the present invention is that despite there being different phases of the alternating current that connect capacitors 94, 104, 114, input terminals S1, as well as secondary exit terminals S2 of second current transformer 98, fourth current transformer 108, and sixth current transformer 118 are connected, respectively, in parallel configuration. This parallel configuration aggregates the powers to transmit them to bridge rectifier 120 to be stored in battery 122. The resulting wattage power can be used in alternating current circuits or in direct current circuits.

The present invention uses a bridge rectifier with 12 volts, 36 amperes and a storage battery of 12 VDC, 12 ampere hour. However, other types of comparable rectifiers and batteries may be used and still remain within the contemplation of the present invention.

The present invention comprises the use of all electrical and electronic devices (such as, by way of example and not limitation, capacitors, electric motors, lamps, resistors, etc. . . . ) of any capacity, voltage, connection or configuration to flow the reactive, capacitive, resistive or inductive current that connects them, through the secondary winding of a current transformer of any capacity, voltage, quantity and configuration, to produce useful energy delivered in watts. The present invention may include any number of wire wounds over the current transformer and cable gauge. Further, any quantity and characteristics of electrical and electronic devices to convert, reduce, increase or store the energy produced with the present invention is also contemplated herein. The energy converted into different phases can be unified into a single output or circuit.

The present invention has application in various industries, including residential and commercial. For example, in residential applications, the system of the present invention may be installed after the city (or municipality or other governing authority) meter but before the residence. In this scenario, the electricity provided by the city is not what is used to turn on the lights, for example, in a residence. Rather, who turns on the lights is the energy that is captured from the magnetic field and converted to electricity. This is separate from the city's electricity grid. It is the surplus converted energy that is used to turn on the lights.

The various embodiments described herein may be used singularly or in conjunction with other similar devices. The present disclosure includes preferred or illustrative embodiments of specifically described apparatuses, assemblies, and systems. Alternative embodiments of such apparatuses, assemblies, and systems can be used in carrying out the invention as described herein. Other aspects and advantages of the present invention may be obtained from a study of this disclosure and the drawings.

I claim:

1. A system for the conversion of capacitive reactive current into useful energy, said system comprising:
a power source;
at least one switch electrically connected to said power source;
at least one current transformer electrically connected to said at least one switch;
a wire having a length sufficient to wind about said at least one current transformer a desired number of times;
at least one capacitor electrically connected to said at least one switch and to at least one current transformer;
a rectifier electrically connected to said at least one current transformer.

2. The system for the conversion of capacitive reactive amperes into useful energy, as recited in claim 1, wherein said at least one capacitor is electrically connected to an inductive, resistive or any other type of electric load that generates ferromagnetic fields to be converted into watts.

3. The system for the conversion of capacitive reactive current into useful energy, as recited in claim 1, wherein said at least one current transformer is of any transformation ratio, voltage level and capacity.

4. The system for the conversion of capacitive reactive current into useful energy, as recited in claim 2, wherein said at least one capacitor is in all KVAR capacities.

5. The system for the conversion of capacitive reactive current into useful energy, as recited in claim 3, wherein said electric load is electrically connected on the secondary side or on the primary side regardless of the capacity and quantity of the wound copper wire of any caliber.

6. The system for the conversion of capacitive reactive current into useful energy, as recited in claim 4, wherein said converted energy is isolated from a conventional electrical network, free of any distortion in the quality of electrical energy and may be stored in batteries, used for lighting, alternating current motors, electric heaters or returned to said conventional electrical network.

7. The system for the conversion of capacitive reactive current into useful energy, as recited in claim 1, wherein said system is in a parallel configuration.
